(19) United States
(12) Patent Application Publication
(10) Pub. No.: US 2008/0026636 A1
(43) Pub. Date: Jan. 31, 2008

(54) Adjustable feed through bushing base

(76) Inventor: Denton L. Jackson, Coldwater, MS (US)

Correspondence Address: Charles F. Rye, Fifth Floor, 8 South Third Street, Memphis, TN, 38103, US

(21) Appl. No.: 11/494,377

(22) Filed: Jul. 27, 2006

(51) Int. Cl. H01R 13/60

(52) U.S. Cl. 439/527

(57) ABSTRACT

This invention relates to providing a means to removeably mount a feed through/grounding bushing commonly used to bond together, ground and/or park power distribution cables. Many pieces of power distribution equipment have U brackets for removable attachment of accessories and temporary placed maintenance equipment. The present invention addresses holding the bushing at an angle relative to the U bracket and surrounding surface and adjustability of the bushing height relative to the U bracket for strain relief and adjusting for improved work room. Also addressed is the advantage of cable identification by numbering the wells so that a lineman may readily select the cables even after the bushing may have been set aside for equipment replacement. This is especially useful on but not limited to this invention since the U bracket mounting means is moveable and would not always provide positive identification of one end of a multi well bushing. Further provided is the method of grounding the lines of a multi phase system on a common bushing in order that a lineman can rely that the entire phase system is grounded and is gives rapid visual confirmation.

### BACKGROUND OF THE INVENTION

This invention relates to providing a means to removeably mount a bushing commonly used to bond together, ground and/or park power distribution cables. It is often necessary for lineman to take power distribution equipment offline and safety ground the associated power cables. This has been accomplished by temporarily mounting a multi well bushing on a U bracket commonly found on most distribution equipment. This operation is often done one line at a time on a two well bushing. Previously available grounding bushings bases normally mounted parallel to the face of the U bracket or its surrounding surface and did not provide any adjustability in relation to the U bracket. The present invention addresses holding the bushing at an angle relative to the U bracket and surrounding surface and adjustability of the bushing height relative to the U bracket for strain relief and adjusting for improved work room.

Temporarily mounted multi well bushings for bonding cables together and especially for grounding are known in the art. U.S. Pat. No. 4,787,855 issued to Finke in 1988 claims a multi well bushing with a U bracket mount with one of the wells providing load breaking and receiving a grounding elbow. 855 further provides for insert wells that allow exchange of the bushing well itself and a three well bushing having a triangular foot print.

U.S. Pat. No. 4,921,433 issued to Biren in 1990 addresses a method of locking a bushing base in place by clamping pressure exerted directly on the U bracket itself and not by an eye bolt dependent on its surrounding surface. 433 would allow rotation of the bushing bracket however, it does not address the need and advantage to vary the height of the bushing relative to the U bracket.

### SUMMARY OF THE INVENTION

The present invention relates to bonding/grounding and parking power distribution lines and provides for the U bracket engaging means to be slide able relative to the bushing holding bracket. The user adjusts the position fixing bracket by loosing the carriage bolt nut, sliding the bracket to a new position and tightening the nut. The U bracket engaging means components are all mounted to the bushing holding bracket by the carriage bolt and travel with the position fixing bracket. The position fixing bracket includes an affixed nut opposite the carriage bolt aperture which accommodates an eye bolt with a dome nut on its end. The eye bolt is advanced to engage the dome nut on the U bracket or surrounding surface to provide a positive location of the bushing. The position fixing bracket can be slid to one end of the bushing holding bracket aligning the eye bolt with the length of the multi well bushing or rotated to about 90 degrees and slid away from the end effectively raising or lowering the bushing relative to the U bracket. In an alternative embodiment the angle bracket channel extends beyond the bushing holding face plate to allow the bushing to be moved to an extreme position relative to the U bracket.

Rapid identification of the busing wells as cables are attached is another improvement offered Especially when changing out equipment the linemen will set the lines and bushing aside or in the hole out of their way. Rapid identification of the cable is provided by numbers on the bushing mount. This may be accomplished by a plate on the side of the bushing mount or a collar plate which slides over the wells and is companionate with the bushing attaching means which may be as simple as bolts that pass through the collar plate to the mounting plate.

Often lineman are relegated to ground testing cables individually on a two well bushing and then setting them aside as they test other cables That method gives rise to the risk of tested cables becoming energized after they have been tested and set aside. The use of an at least three well bushing presents the ability to test and park cables fully grounded. Further presented is the method of grounding a four well bushing and testing/parking the cables of a three phase system. Through the efforts of this inventor this method of ground bonding all phases of a multi phase system has been approved by safety standards committee of a major power distribution company. When first exposed to this method some personnel in the power distribution industry have expressed concern that if an energized line is introduced to the bushing that it would energize all other cables present on the bushing. This concern is valid but if an energized line is introduced it would be faulted out by the ground and indicates that there is a major problem with line configuration at other connections which should be addressed before any further maintenance is preformed. The total safety improvement of having all phases verifiably grounded at a single location is readily perceived by linemen. The advantage of this method may be expanded to involve an even greater number of power lines.

### BRIEF DESCRIPTION OF THE DRAWINGS

FIG. 1 is a top view of the U bracket flange.

FIG. 2 is a top view of the U bracket spacer.

FIG. 3 is a top view of the position fixing bracket blank prior to forming on the indicated break lines.

FIG. 4 is a top view of the bushing face plate.

FIG. 5 is a front side view of the angle channel bracket blank prior to forming on the indicated break lines.

FIG. 6 is an exploded view of the mounting plate assembly with assembled groups within.

FIG. 7 is a side view of the mounting plate assembly including a number plate and a three well bushing.

### DETAILED DESCRIPTION OF THE DRAWINGS

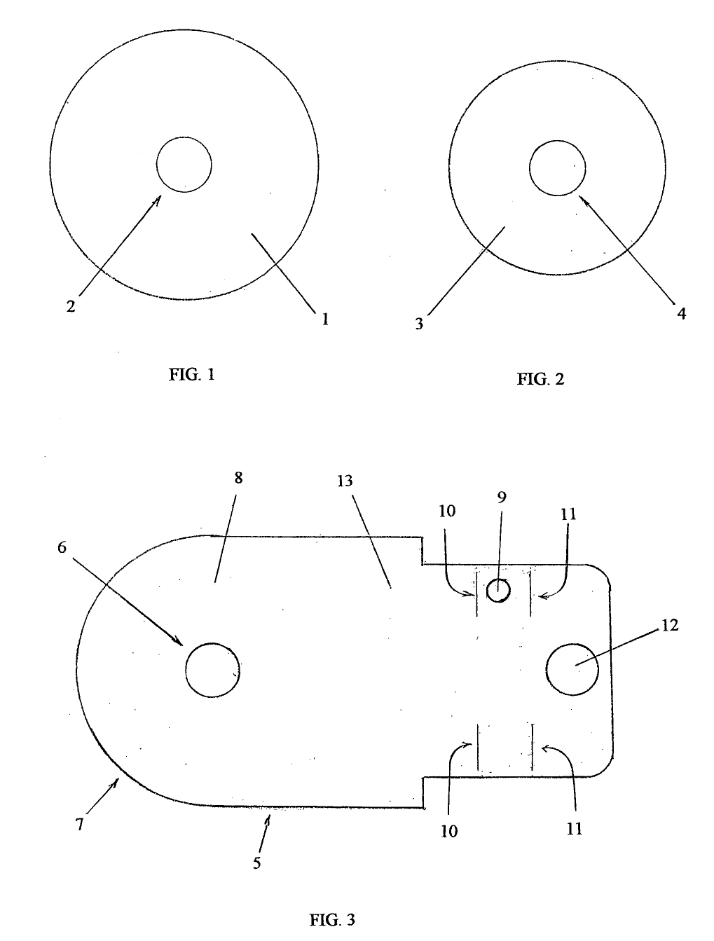

FIG. 1 shows a top view of U bracket flange 1 which has first carriage bolt aperture 2 centrally located.

FIG. 2 shows a top view of U bracket spacer 3 which has second carriage bolt aperture 4 centrally located.

FIG. 3 shows a top view of position fixing bracket blank 5 which has third carriage bolt aperture 6 centered on end radius 7 at first end 8. Bleed grounding attachment aperture 9 is located between forming break line 10 and 11. Eye bolt aperture 12 is shown generally centered and proximal to second end 13.

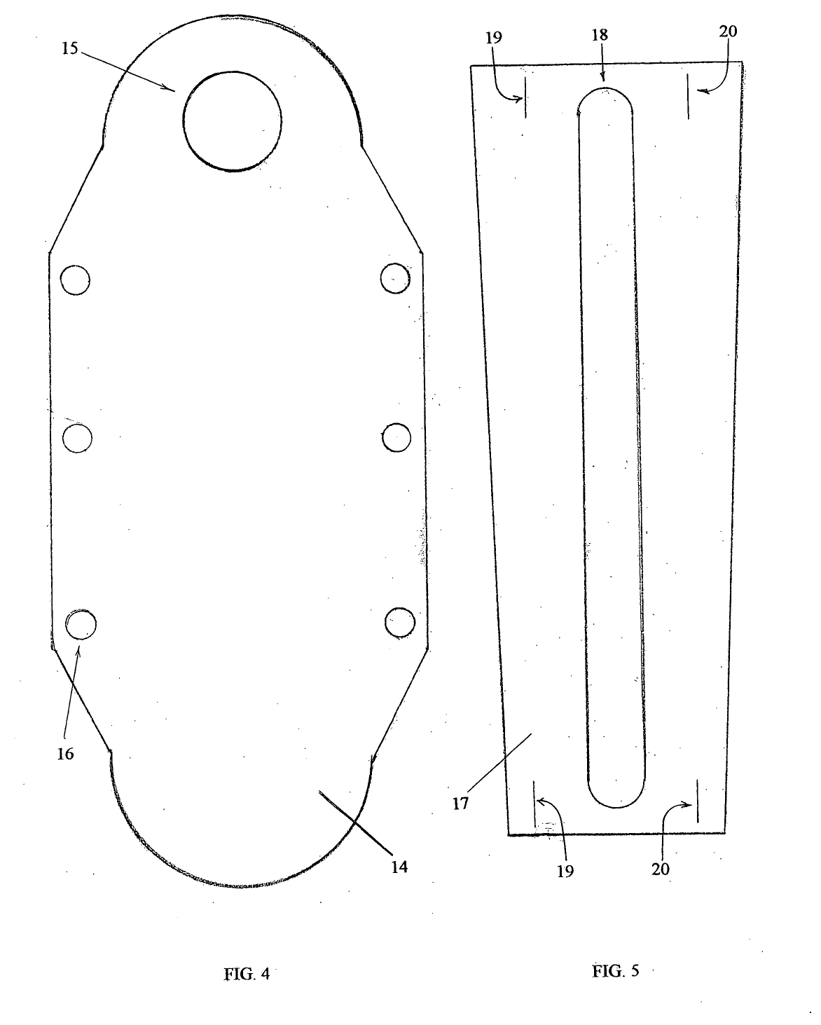

FIG. 4 shows a top view of bushing face plate 14. Shown a one end of bushing face plate 14 is carriage bolt head aperture 15 and on opposing sides multiple bushing mounting apertures 16.

FIG. 5 shows a top view of angle channel bracket blank 17 prior to forming. Carriage bolt elongated aperture 18 is shown along with forming break lines 19 and 20.

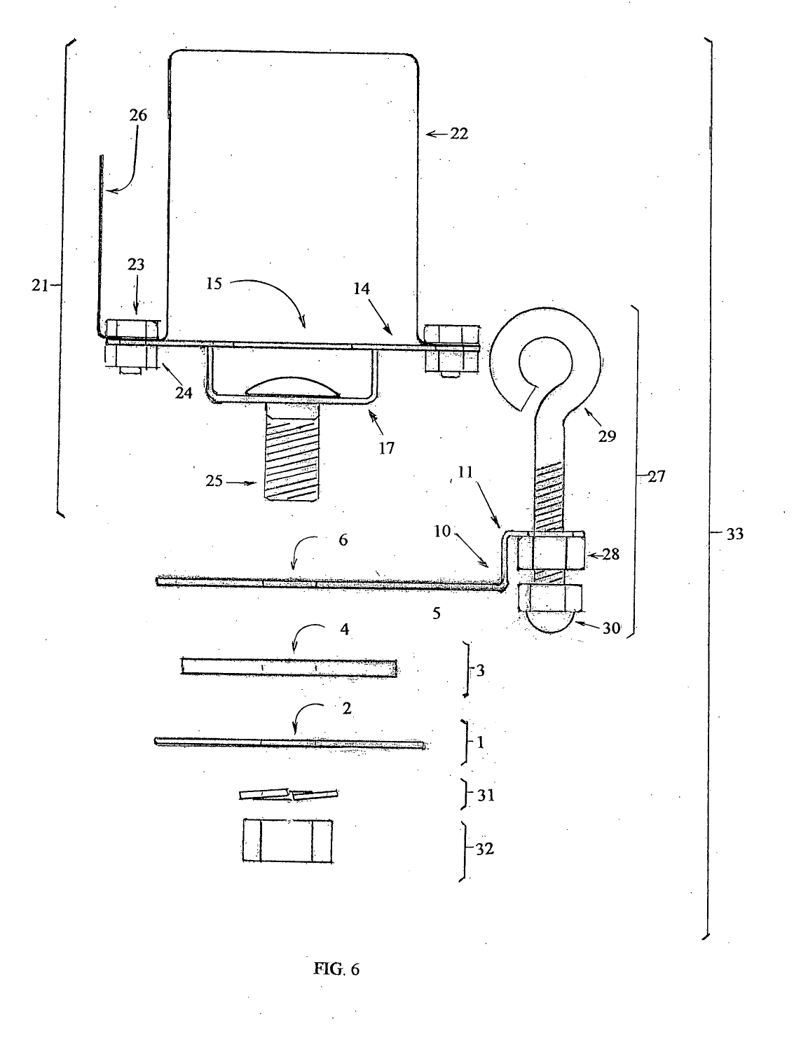

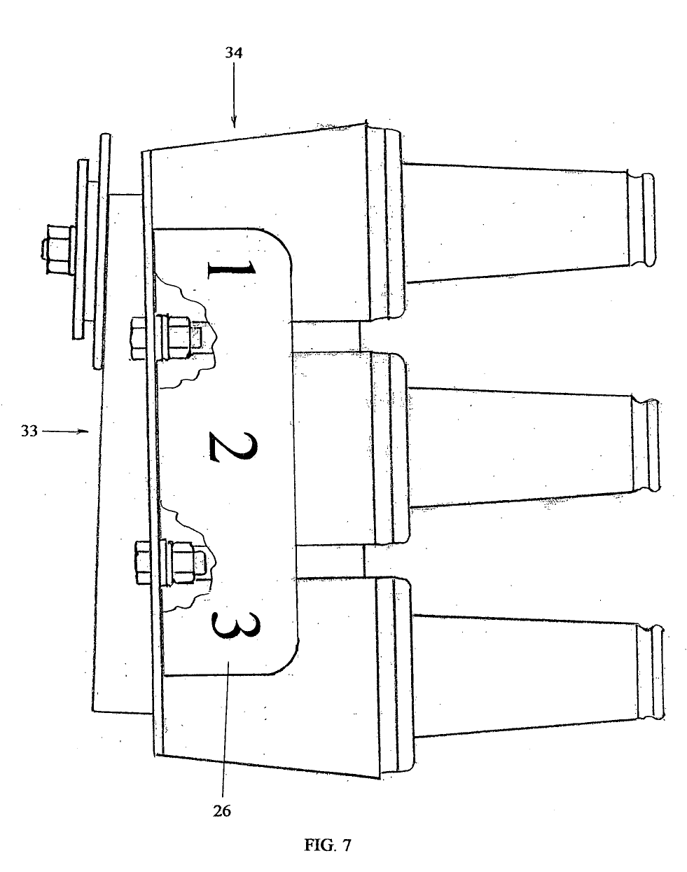

FIG. 6 Shows an exploded end view of mounting plate assembly 33. Angle channel 17 is shown as formed and affixed to bushing face plate 14 and bushing holding loop 22 and number plate 26 are joined by bushing mounting bolts 23 and nuts 24 and carriage bolt 25 is shown engaged in carriage bolt aperture 18 (FIG. 5) having been passed through carriage bolt head aperture 15 and are shown together as assembly 21. Position fixing bracket assembly 27 is shown with position fixing bracket blank 5 having been formed on break lines 10 and 11. Eye bolt nut 28 is affixed to position fixing bracket blank 5 and eye bolt 29 is advanced through eye bolt nut 28 and dome nut 30 is advanced on the thread end of eye bolt 29. Position fixing bracket assembly 27 is aligned on carriage bolt 25 by way of third carriage bolt aperture 6 as is U bracket spacer 3 by way of second carriage bolt aperture 4 and as is U bracket flange 1 by way of first carriage bolt aperture 2. Lock washer 31 is shown in alignment with carriage bolt 25 as is carriage nut 32.

FIG. 7 shows a side view of mounting plate assembly 33 with number plate 26 shown for clarity and three well bushing 34 mounted on it.

The embodiment described in this specification and shown in the drawings are not intended as limitations on the invention. Those skilled in the art can envision variations of the concept to adapt to specific needs in peculiar situations and the general usefulness of the concept as temporary mounting means vary as power distribution equipment maintenance common practices evolve.

I claim:

1. An apparatus for grounding, bonding and/or parking power distribution cables which is adapted to be removeably mounted on a U bracket commonly utilized on transformers and especially pad mount underground equipment, switching cabinets and other power distribution equipment comprising;
a multi well bushing;
a mounting plate assembly;
said mounting plate assembly further comprising:
a mounting plate;
a U bracket mounting means slideably affixed to said mounting plate further including a position fixing means which engages said U bracket or its surrounding surface;
a bushing mounting means;
said bushing affixed to said mounting plate; and
a bushing identification means affixed to said mounting plate or said bushing mounting means

2. The apparatus of claim 1 wherein:
said mounting plate assembly holds said bushing at a predetermined angle other than parallel to said U bracket or its surrounding surface.

3. The apparatus of claim 1 wherein:
Said mounting plate extends beyond one end of said bushing.

4. The apparatus of claim 1 wherein:
said mounting plate assembly holds said bushing at a predetermined angle other than parallel to said U bracket or its surrounding surface; and
said mounting plate extends beyond one end of said bushing.

5. An apparatus for grounding, bonding and/or parking power distribution cables which is adapted to be removeably mounted on a U bracket commonly utilized on transformers and especially pad mount underground equipment, switching cabinets and other power distribution equipment comprising;
a multi well bushing affixed to a mounting plate assembly;
said multi well bushing having at least two wells adaptive to receive cable end terminations commonly utilized in power distribution and generally two, three or four wells which are bonded in electrical communication with each other;
said mounting plate assembly further comprising:
a Carriage bolt with companionate lock washer and nut;
a U slot flange having a thickness and having a circumference generally greater that the U opening of said U bracket and less than the distance between the U bracket sides and defining a centrally located aperture which accommodates the shank of said carriage bolt;
a U slot spacer having a thickness generally greater than the thickness of said U bracket's material and having a diameter generally less than the width of the U opening of said U bracket defining a centrally located aperture which accommodates the shank of said carriage bolt;
a face plate whose profile approximates the foot print of said bushing's base having a front, a back and side having regions which extend past the true foot print of said bushing base which define bushing mounting apertures and further defining an aperture adaptive for said carriage bolt head to pass through generally centered relative to the mounted position of an end well of said bushing;
bushing mounting means which engage said bushing and align with said bushing mounting apertures; fasteners adaptive to said bushing mounting means and said bushing mounting apertures;
an angled bracket channel with a base and two blades and a first and a second end and a length;
said blades are generally ninety degrees relative said base and parallel relative to each other length wise and height wise
said blades are of one height at said first and of a different height at said second end
said base of said angle bracket defining an elongated aperture whose width slideably engages the square head base of said carriage bolt and generally centrally located relative to the width of said base and generally extending less than the full length of said base;
said angle bracket channel blades affixed to the backside of said face plate
a position fixing bracket comprising:
a position fixing bracket plate (PFB);
an eye bolt;
an eye bolt nut;
an eye bolt dome nut;
said PFB having a first end, a second end, width and a length,
said PFB width equal to or greater that the diameter of said U slot flange,
said PFB first end's periphery being a 180 degree convex generally consistent radius about equal to one half said PFB width
said PFB second end being unitary with said PFB first end and generally being rectangular
said PFB second end opposite said PFB first end being formed perpendicular to its center line about two opposite break lines generally 90 degrees forming a step profile wherein the first break line is a greater distance from the center point of the radius of said PFB first end than half the width of said face plate at its widest point
said PFB first end defining an aperture adaptive to receiving said carriage bolt's shank
said PFB second end raised step portion defining a centrally located eye bolt aperture adaptive to receive said eye bolt's shank
said PFB second end defining an aperture adaptive to receive a voltage bleeding means;
said eye bolt nut affixed to said PFB second end aligned with said eye bolt aperture;
said eye bolt advanced through said eye bolt nut;
said eye bolt dome nut semi permanently affixed to the lead end of said eye bolt; and
said carriage bolt passed through said face plate's carriage bolt aperture and passed through said angle bracket's elongated aperture slidably engaging said carriage bolt's square head base, said position fixing bracket engaged on said carriage bolt with its step toward said face plate, said U slot spacer engaged on said carriage bolt, said U slot flange engaged on said carriage bolt, said lock washer engaged on said carriage bolt said carriage bolt nut advanced on said carriage bolt;
said bushing affixed to said face plate by said bushing mounting means; and
a bushing identification means attached to said mounting plate assembly or said bushing mounting means.

6. The apparatus of claim 5 wherein:
said mounting plate assembly further comprises:
the blades of said angle bracket channel not being permanently affixed directly to said face plate;
a third and forth blade affixed to said face which are parallel with and slide against the blades of said angle bracket channel;
the first end of said third and forth blade and said angle bracket channel defining aligning pivot apertures;
the second end of said third and forth blade and said angel bracket channel defining a multitude of companionate angle setting apertures;
a pivot bolt; and
an angle setting bolt.

7. The apparatus of claim 5 wherein:
said angle bracket channel and said elongated aperture extends beyond one end of said bushing.

8. The apparatus of claim 5 wherein:
said mounting plate assembly further comprises:
the blades of said angle bracket channel not being permanently affixed directly to said face plate;
two angle plates affixed to said face which are parallel with and slide against the blades of said angle bracket channel;
the first end of said angle plates and said angle bracket channel defining aligning pivot apertures;
the second end of said angel plates and said angel bracket channel defining a multitude of companionate angle setting apertures;
a pivot bolt;
an angle setting bolt; and
said angle bracket channel and said elongated aperture extends beyond one end of said bushing.

9. A method of grounding all phases of a multi phase electrical power distribution lines either to break said lines from their source of power and/or to safety the lines down stream of a disconnect comprising the steps of:
a) Identify the individual lines that make up each phase of a multi phase power system in which the total number of phases equal X at a location having end terminations on each said line;
b) providing a grounding bushing that has X plus 1 wells bonded in electrical communication with each other, said wells companionate to said end terminations;
c) stabilizing/mounting said grounding bushing proximate to said location;
d) attaching a grounded cable to one well of said grounding bushing generally with a load break device in line;
e) removing an end termination of a line of said multi phase power system and attaching to and it in electrical communication with said grounding bushing; and
f) repeating step e for each leg of said multi phase power system.
